(19) United States
(12) Patent Application Publication
(10) Pub. No.: US 2026/0285011 A1
(43) Pub. Date: Sep. 24, 2026

(54) MULTILAYER STACK FOR PROTECTING A SCREEN

(71) Applicant: Auto Konnect LLC, Auburn Hills, MI (US)

(72) Inventors: Roger Caramanoff, Huntington Beach, CA (US); Alan Birkle, Madison, WI (US)

(21) Appl. No.: 19/478,396

(22) PCT Filed: May 30, 2024
(86) PCT No.: PCT/US2024/031760

§ 371 Date: Oct. 24, 2025

Related U.S. Application Data
(60) Provisional application No. 63/505,321, filed on May 31, 2023.

(51) Int. Cl. B32B 17/10; B32B 37/26; B60K 35/23; G02B 27/01

(52) U.S. Cl. CPC B32B 17/10018; B32B 17/10119; B32B 17/10128; B32B 17/10779; B32B 37/26; B60K 35/23; G02B 27/0172; B32B 2037/268; B32B 2307/408; B32B 2307/412; B32B 2307/42; B32B 2307/71; B32B 2307/7145; B32B 2307/748; B32B 2457/20; B32B 2605/00; B60K 2360/20; B60K 2360/693; B60K 2360/96

(57) ABSTRACT

Disclosed is a multilayer stack for protecting a screen that can include a bottom layer, a top layer, and a plurality of interlayers disposed between the bottom layer and top layer. The plurality of interlayers can include an optically clear adhesive layer, an anti-refraction layer and/or an anti-reflection layer. The multilayer stack may substantially retain its color, plasticity and/or limit outgassing over its use.

### INCORPORATION BY REFERENCE TO ANY PRIORITY APPLICATIONS

Any and all applications for which a foreign or domestic priority claim is identified in the Application Data Sheet or PCT Request as filed with the present application are hereby incorporated by reference under 37 CFR 1.57, and Rules 4.18 and 20.6. This application claims the benefit of U.S. Provisional Application No. 63/505,321, filed May 31, 2023, the entirety of which is hereby incorporated herein by reference for all purposes.

### BACKGROUND

### Field

The present disclosure relates to multilayer stacks. More specifically, the present disclosure relates to multilayer stacks for protecting a screen.

### Description of the Related Art

Screens may be covered by a protective layer that provides protection from direct trauma (e.g., scratches, cracks, and impact) and/or contamination (e.g., dust, debris, and fingerprint residue). However, typical protective layers are susceptible to degradation over time through daily temperature cycles and/or radiation (e.g., solar ultraviolet radiation). Such degradation can cause the protective layer to change color (e.g., yellowing), outgas and develop trapped gas bubbles, lose its plasticity thereby becoming brittle and susceptible to cracking or breaking, and/or become difficult to remove. For example, a screen protector that was optically transparent and colorless when purchased or installed (i.e., when new) can discolor (e.g., yellow) over time, thereby reducing transmission of light through the screen protector and reducing transparency and color accuracy. As another example, outgassing may form gas bubbles within the screen protector or between the screen protector and the screen that interfere with the optical clarity and/or diminish the physical strength of the screen protector. As a further example, diminished plasticity in a screen protector may cause removal of the screen protector to lead to cracking of the screen protector and/or breaking/tearing of the screen protector into a plurality of pieces. As yet another example, degradation may cause removal of the screen protector to lead to the deposition of residue on the screen.

This degradation limits use of such protective layers.

### SUMMARY

For purposes of summarizing the disclosure and the advantages achieved over the prior art, certain objects and advantages of the disclosure are described herein. Not all such objects or advantages may be achieved in any particular embodiment. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments will become readily apparent to those skilled in the art from the following detailed description of the preferred embodiments having reference to the attached figures, the invention not being limited to any particular preferred embodiment(s) disclosed.

In one aspect, a multilayer stack for protecting a screen is described. The multilayer stack comprises: a bottom layer; a top layer; and a plurality of interlayers disposed between the bottom layer and top layer, wherein the plurality of interlayers comprises an optically clear adhesive layer.

In some embodiments, the multilayer stack is optically transparent. In some embodiments, the multilayer stack further comprises a release layer disposed directly below the bottom layer. In some embodiments, the plurality of interlayers includes an anti-refraction layer. In some embodiments, the plurality of interlayers comprises a polyethylene terephthalate (PET) layer. In some embodiments, the PET layer is a polarized PET layer. In some embodiments, the polarized PET layer comprises a circular polarizer. In some embodiments, the plurality of interlayers comprises a glass layer. In some embodiments, the plurality of interlayers comprises an anti-reflection layer. In some embodiments, a device comprises a screen and the multilayer stack, wherein the screen is disposed directly below the bottom layer. In some embodiments, the screen is a head unit screen. In some embodiments, a vehicle comprises the device. In some embodiments, the multilayer stack is configured to withstand exposure to ambient radiation over the course of a useful life without substantial degradation. In some embodiments, a useful life is about at least 4 years, about at least 5 years, about at least 6 years, about at least 8 years, or about at least 10 years. In some embodiments, the multilayer stack meets or exceeds an SAE J2527 accelerated exposure standard. In some embodiments, the multilayer stack is configured to substantially retain its color over the course of a useful life. In some embodiments, the multilayer stack is configured to not form bubbles between the stack and the screen over the course of a useful life. In some embodiments, the multilayer stack is configured to substantially retain its plasticity over the course of a useful life. In some embodiments, the multilayer stack is configured to be easily removable from a glass element after 12 years of being directly disposed over the glass element without leaving residue on the glass element. In some embodiments, a method of applying a screen protector to a screen comprises disposing the multilayer stack to a screen. In some embodiments of said method, the multilayer stack further comprises a release layer disposed directly below the bottom layer, and further comprising removing the release layer from the multilayer stack prior to disposing the multilayer stack to the screen.

In another aspect, a multilayer stack for protecting a screen is described. The multilayer stack comprises: a silicon-based layer; an anti-refraction layer disposed directly over the silica gel layer; an optically clear adhesive layer disposed directly over the anti-refraction layer; a tempered glass layer disposed directly over the optically clear adhesive layer; and an anti-fingerprint layer disposed directly over the tempered glass layer.

In some embodiments, the tempered glass layer comprises silver ions. In some embodiments, the multilayer stack further comprises an anti-bacterial anti-fingerprint layer disposed over the tempered glass layer. In some embodiments, the tempered glass layer has anti-glare properties. In some embodiments, the anti-reflection layer is disposed directly over the tempered glass layer. In some embodiments, the optically clear adhesive layer is configured to withstand exposure to ambient radiation over the course of a useful life without substantial degradation. In some embodiments, the optically clear adhesive layer meets or exceeds an SAE J2527 accelerated exposure standard.

### BRIEF DESCRIPTION OF THE DRAWINGS

The detailed description is set forth with reference to the accompanying figures. The use of the same reference numbers in different figures indicates similar or identical items.

For this discussion, the devices and systems illustrated in the figures are shown as having a multiplicity of components. Various implementations of devices and/or systems, as described herein, may include fewer components and remain within the scope of the disclosure. Alternatively, other implementations of devices and/or systems may include additional components, or various combinations of the described components, and remain within the scope of the disclosure.

These aspects and others will be apparent from the following description of preferred embodiments and the accompanying drawings, which are meant to illustrate and not to limit the invention.

FIG. 1A is an exploded view of a multilayer stack for protecting a screen, according to one embodiment, with a high-definition-finished tempered glass layer.

FIG. 1B is an exploded view of a multilayer stack for protecting a screen, according to one embodiment, with a matte-finished tempered glass layer.

FIG. 1C is an exploded view of a multilayer stack for protecting a screen, according to one embodiment, with a high-definition-finished tempered glass layer and a rectify polarization polyethylene terephthalate (PET) layer.

FIG. 1D is an exploded view of a multilayer stack for protecting a screen, according to one embodiment, with a matte-finished tempered glass layer and a rectify polarization polyethylene terephthalate (PET) layer.

FIG. 1E is an exploded view of a multilayer stack for protecting a screen, according to one embodiment, with a 9H tempered glass layer.

FIG. 1F is an exploded view of a multilayer stack for protecting a screen, according to one embodiment, with a 9H tempered glass with anti-glare properties.

FIG. 1G is an exploded side view of a multilayer stack for protecting a screen with an anti-reflective layer, according to one embodiment.

FIG. 2A is a photographic image comparing indirect reflection of an off screen with and without multilayer stacks, according to embodiments.

FIG. 2B is a photographic image comparing indirect reflection of an on and blue screen with and without multilayer stacks, according to embodiments.

FIG. 2C is a photographic image comparing indirect reflection of an on and multi-colored screen with and without multilayer stacks, according to embodiments.

FIGS. 3A-3C are photographic images comparing direct reflection (e.g., glare) on a screen with and without multilayer stacks, according to embodiments.

### DETAILED DESCRIPTION

The present disclosure may be understood by reference to the following detailed description. It is noted that, for purposes of illustrative clarity, certain elements in various drawings may not be drawn to scale, may be represented schematically or conceptually, or otherwise may not correspond exactly to certain physical configurations of embodiments.

Embodiments of the present disclosure relate to a multilayer stack for protecting a screen comprising an optically clear adhesive (OCA) disposed between bottom and top layers. In some embodiments, the multilayer stack can include one or more additional layers selected from a silicon-based layer (e.g., silica gel and/or silicone adhesive), an anti-refraction layer (e.g., triacetate cellulose (TAC) and/or polyethylene terephthalate (PET) (e.g., polarized PET)), glass (e.g., tempered glass, for example ACG glass), anti-reflective layer, a release layer and/or an anti-fingerprint material. In some embodiments, the multilayer stack comprises one or a plurality of interlayers disposed between the top and bottom layers, including silica gel, polyethylene terephthalate (PET) (e.g., polarized PET) and/or glass (e.g., tempered glass). In some embodiments, the multilayer stack comprises one or a plurality of interlayers disposed between the top and bottom layers, including a silicon-based layer, an anti-refraction layer, glass (e.g., tempered glass), and/or an anti-reflective layer. In some embodiments, the multilayer stack provides protection from direct trauma (e.g., scratches, cracks, and shattering) and/or contamination (e.g., dust, dirt, and fingerprint residue). In some embodiments, the multilayer stack may be applied, reversibly or irreversibly, to screens or other glass elements. In some embodiments, the multilayer stack is, or is substantially, optically transparent and/or colorless.

In some embodiments, the multilayer stack comprises a silicon-based layer. In some embodiments, the silicon-based layer is selected from silica gel, a silicone adhesive, and combinations thereof. In some embodiments, the bottom layer of the multilayer stack comprises a silicon-based layer. In some embodiments, the silicon-based layer is disposed, or disposed directly, over the bottom layer of the multilayer stack. In some embodiments, the silicon-based layer is disposed between the bottom layer and the top layer of the multilayer stack. In some embodiments, the interlayer comprises the silicon-based layer. In some embodiments, the silicon-based layer can be the bottom layer of the multilayer stack that is, or is configured to be, disposed directly over a screen. In some embodiments, the silicon-based layer adheres to the screen. In some embodiments, the silicon-based layer can be removed from the screen over which it was directly disposed. In some embodiments, the silicon-based layer is configured to be removable from a screen without, or without substantially, leaving residue of the silicon-based layer deposited on the screen over which it was directly disposed. In some embodiments, the silicon-based layer is resistant to degradation (e.g., yellowing, degassing, loss of plasticity) caused by temperature changes (e.g., heating and/or cooling) and/or radiation (e.g., ultraviolet radiation). An ability for a component to withstand exposure to radiation can be simulated by using accelerated exposure. In some embodiments, the silicon-based layer meets or exceeds vehicle ultraviolet-protection standards promulgated by a recognized standards organization, such as the Society of Automotive Engineers (SAE) (e.g., SAE J2527 accelerated exposure standard). In some embodiments, the silicon-based layer can have a thickness of, of about, of at most, or of at most about, 0.01 mm, 0.015 mm, 0.02 mm, 0.025 mm, 0.03 mm, 0.035 mm, 0.04 mm, 0.045 mm, 0.05 mm, 0.1 mm, 0.15 mm, 0.2 mm, 0.3 mm, 0.5 mm or 1 mm, or any range of values therebetween.

In some embodiments, the multilayer stack comprises an anti-refraction layer. In some embodiments, the anti-refraction layer also have anti-reflection properties (e.g., reduces direct reflections (e.g., includes anti-glare properties). In some embodiments, the anti-refraction layer comprises a triacetate cellulose (TAC) layer. In some embodiments, the anti-refraction layer comprises a polyethylene terephthalate (PET) layer. In some embodiments, the anti-refraction layer is disposed between the bottom layer and the top layer of the multilayer stack. In some embodiments, the interlayer comprises an anti-refraction layer. In some embodiments, the anti-refraction layer is disposed, or disposed directly, over a silicon-based layer. In some embodiments, the anti-refraction layer is, or is substantially, colorless. In some embodiments, the anti-refraction layer comprises a polarized PET layer. In some embodiments, examples of a polarized PET layer can include a circular polarizer, rectify polarizer, birefringent polarizer, an optical birefringent polarizer, or combinations thereof. In some embodiments, the polarized PET layer comprises a rectify polarization PET layer. For example, PET can be processed to have desired optical properties, such as polarization. In some embodiments, such a polarizer can reduce or eliminate reflections (e.g., direct reflections such as glare, indirect reflections, and so on) and/or the “rainbow effect” that may be observed by a viewer when a viewer is wearing polarized glasses (e.g., polarized sunglasses). The “rainbow effect” can occur when light from a light source (e.g., a screen) is transmitted through two transparent layers of materials, where at least one material may develop internal stresses that cause different optical effects on different wavelengths of light, and the “rainbow effect” can be seen when the screen is viewed through a polarized lens (e.g., polarized glasses). In some embodiments, the rainbow effect can be mitigated by transmitting the light through a circular polarizer. In some embodiments, the PET layer can have a thickness of, of about, of at most, or of at most about, 0.01 mm, 0.02 mm, 0.03 mm, 0.04 mm, 0.05 mm, 0.06 mm, 0.07 mm, 0.08 mm, 0.09 mm, 0.1 mm, 0.15 mm, 0.2 mm, 0.3 mm, 0.4 mm, 0.5 mm or 1 mm, or any range of values therebetween.

The multilayer stack includes an optically clear adhesive (OCA) layer. In some embodiments, the OCA layer adheres the layers below it to the layers above it. In some embodiments, the OCA layer is disposed between the bottom layer and the top layer of the multilayer stack. In some embodiments, the interlayer comprises the OCA layer. In some embodiments, the OCA layer is disposed, or disposed directly, over an anti-refraction layer. In some embodiments, the OCA layer is resistant to degradation caused by temperature changes (e.g., heating and cooling) and/or radiation (e.g., ultraviolet radiation). Such degradation can cause screen protectors to not retain their color (e.g., to yellow), to degas (e.g., to develop gas bubbles within the stack or between the stack and the screen over which the stack is disposed), or to lose plasticity (e.g., to become brittle, which can cause a screen protector to crack or break). An ability for a component to withstand exposure to radiation can be simulated by using accelerated exposure. In some embodiments, the OCA layer meets or exceeds vehicle ultraviolet-protection standards promulgated by a recognized standards organization, such as the Society of Automotive Engineers (SAE). In some embodiments, the OCA layer meets or exceeds SAE standard J2527 and/or SAE standard J2412. Such an ability to withstand simulated exposure to radiation can contribute to substantial retention of color, reduction of degassing, and substantial retention of plasticity over a period of use. In some embodiments, the optically clear adhesive (OCA) layer is configured to withstand exposure to temperature changes and/or radiation over for, for about, for at least, or for at least about, 1, 2, 3, 4, 5, 6, 7, 8, 9 or 10 years, or any rage of values therebetween, without, or without substantial, degradation. Radiation (e.g., ambient radiation) can include solar radiation, which comprises solar ultraviolet (UV) radiation. In some embodiments, the OCA layer can have a thickness of, of about, or at most, or of at most about, 0.02 mm, 0.03 mm, 0.04 mm, 0.05 mm, 0.08 mm, 0.085 mm, 0.09 mm, 0.095 mm, 0.1 mm, 0.11 mm, 0.12 mm, 0.15 mm, 0.2 mm, 0.3 mm, 0.4 mm, 0.5 mm or 1 mm, or any range of values therebetween.

In some embodiments, the multilayer stack comprises a glass layer. In some embodiments, the top layer is a glass layer. In some embodiments, the glass layer is disposed between the bottom layer and the top layer of the multilayer stack. In some embodiments, the interlayer comprises the glass layer. In some embodiments, the glass layer is disposed, or disposed directly, over an OCA layer. In some embodiments, the glass is a tempered glass. In some embodiments the tempered glass is ACG glass. In some embodiments, the glass is a high-definition (HD) glass (e.g., HD tempered glass). In other embodiments, the glass is a matte glass (e.g., matte tempered glass). In some embodiments, the glass has a scratch resistance rating of, of about, of at least, or of at least about, 9B, 9C, 9D, 9E, 9F, 9G or 9H, or any range of values therebetween. In some embodiments, the glass has a 9H scratch resistance rating (e.g., tempered 9H glass). In some embodiments, the glass layer comprises silver ions, which may provide antibacterial and/or antimicrobial properties. In some embodiments, the glass layer reduces reflections. In some embodiments, the glass layer reduces direct reflections (e.g., includes anti-glare properties). In some embodiments, the glass layer reduces indirect reflection (e.g., includes anti-reflection properties, which includes reducing reflections in bright conditions). In some embodiments, the glass layer comprises anti-glare and/or anti-reflection properties. In some embodiments, the glass layer can have a thickness of, of about, at most, or of at most about, 0.1 mm, 0.2 mm, 0.25 mm, 0.3 mm, 0.33 mm, 0.35 mm, 0.4 mm, 0.45 mm, 0.5 mm, 0.55 mm, 0.6 mm, 0.7 mm, 0.8 mm, 0.9 mm, 1 mm or 2 mm, or any range of values therebetween.

In some embodiments, the multilayer stack comprises an anti-reflective layer. The anti-reflective layer reduces reflections (e.g., direct reflections (i.e., includes anti-glare properties) and/or indirect reflections (i.e., includes anti-reflection properties, which includes reducing reflections in bright conditions)). In some embodiments, the top layer is an anti-reflective layer. In some embodiments, the anti-reflective layer is disposed between the bottom layer and the top layer of the multilayer stack. In some embodiments, the interlayer comprises the anti-reflective layer. In some embodiments, the anti-reflective layer is disposed, or disposed directly, over a glass layer. In some embodiments, the anti-reflective layer is a thin layer of metal. In some embodiments, the anti-reflective layer comprises gallium. In some embodiments, the anti-reflective layer is deposited by a physical vapor deposition (PVD) technique. In some embodiments, the anti-reflective layer is deposited by magnetron sputtering. In some embodiments, the anti-reflective layer is uniformly or substantially uniformly deposited. In some embodiments, the anti-reflective layer comprises anti-reflection and/or anti-glare properties. In some embodiments, the anti-reflective layer can have a thickness of, of about, at most, or of at most about, 0.005 mm, 0.006 m, 0.007 m, 0.008 m, 0.009 m, 0.01 mm, 0.015 mm, 0.02 mm, 0.025 mm, 0.03 mm, 0.033 mm, 0.035 mm, 0.04 mm, or any range of values therebetween.

As the term is used throughout this application, unless otherwise specified, “reflection” is a general term to describe the phenomenon of an unintended object being reflected off the multilayer stack and/or screen and visible to a user. The term “reflection” encompassing both direct reflection and indirect reflection. Direct reflection occurs when the unintended object itself is a light source, for example the sun or a light bulb. One example of direct reflection is glare, for example, when a viewer of a screen sees a bright spot on the screen, where the bright spot is a reflection of the sun or a light bulb. Indirect reflection occurs when the unintended object is not itself a light source. One example of indirect reflection is when a viewer of a screen sees a reflection of their own face on the screen.

By the definition of “reflection” provided herein, it will be understood that the anti-reflection layer reduces both direct reflection (e.g., glare) and/or indirect reflection. The anti-reflective layer can also have anti-glare properties. In some embodiments, the anti-reflective layer reduces direct reflection. In some embodiments, the anti-reflective layer reduces indirect reflection.

In some embodiments, the multilayer stack comprises an anti-fingerprint layer. In some embodiments, the top layer is the anti-fingerprint layer. In some embodiments, the anti-fingerprint layer is disposed over, or directly over, a glass layer. In other embodiments, the anti-fingerprint layer is disposed over, or directly over, an anti-reflective layer. In some embodiments, the anti-fingerprint layer comprises an oleophobic material or film. In some embodiments, the anti-fingerprint layer can reduce or minimize the intensity or visibility of fingerprints. In some embodiments, the anti-fingerprint layer can also reduce the incidence of smudges on the screen. In some embodiments, the anti-fingerprint layer can help make the multilayer stack easier to clean (e.g., to remove contamination (e.g., dust, debris, and fingerprint residue) from the surface of the multilayer stack). In some embodiments, the anti-fingerprint layer can have anti-microbial (e.g., anti-bacterial) properties. In some embodiments, the anti-fingerprint layer can have a thickness of, of about, of at most, or of at most about 0.005 mm, 0.007 mm, 0.009 mm, 0.01 mm, 0.011 mm, 0.013 mm, or 0.15 mm, 0.2 mm, 0.3 mm or 0.5 mm, or any range of values therebetween.

In some embodiments, the multilayer stack comprises a release layer. In some embodiments, the release layer is the bottom layer. In some embodiments, the release layer is disposed below, or directly below, the silicon-based layer. In some embodiments, the release layer protects the multilayer stack, such as the silicon-based layer, during shipment, and during installation the release layer is removed such that the multilayer stack absent the release layer may be deposited onto a screen. In embodiments where the release layer is removed from the multilayer stack, the layer adjacent to the release layer may be referred to as the bottom layer or the new bottom layer. In embodiments where the release layer is removed from the multilayer stack, the multilayer stack absent the release layer may be referred to as the multilayer stack. In embodiments where the multilayer stack comprises the release layer, the multilayer stack with the release layer may be referred to as the covered multilayer stack. In some embodiments, the release layer comprises a plastic material. In some embodiments, the release layer is removably adhered to the remainder of the multilayer stack by static force (i.e., “static cling”). In some embodiments, the release layer is robust enough to not tear or fail during removal. In some embodiments, the release layer can have a thickness of, of about, of at most, or of at most about, 0.01 mm, 0.02 mm, 0.03 mm, 0.04 mm, 0.05 mm, 0.06 mm, 0.07 mm, 0.075 mm, 0.08 mm, 0.09 mm, 0.1 mm, 0.11 mm, 0.15 mm, 0.2 mm, 0.3 mm, 0.4 mm or 0.5 mm, or any range of values therebetween.

The multilayer stack is configured to be disposed over a screen, thereby forming a device. In some embodiments, the bottom layer of the multilayer stack is disposed directly over the screen. In some embodiments, examples of screens include those of a mobile device, a monitor (e.g., for a computer, television or electronic tablet), embedded in or placed on the rear of seats (e.g., seats in a vehicle or airplane), and/or a vehicle head unit. In some embodiments, a vehicle head unit can be a user interface, display, and/or control system on/near a dashboard of a vehicle. In some embodiments, the vehicle head unit screen can be sensitive to direct human touch (e.g., a “touch screen”), or a static screen. In some embodiments, the multilayer stack does not interfere with the touch screen capability of a screen.

In some embodiments, the multilayer stack does not become brittle after years of exposure to ultraviolet radiation; the multilayer stack remains bendably flexible. In some embodiments, the multilayer stack can bend about, at least, or at least about 120°, 130°, 140°, 150°, 160°, 170°, 180°, 185°, or 190°, or any range of values therebetween. In some embodiments, increasing the multilayer stack's bendable flexibility reduces or eliminates the likelihood that the multilayer stack will either break or leave residue on the screen when the multilayer stack is removed.

In some embodiments, the multilayer stack meets or exceeds vehicle ultraviolet-protection standards promulgated by a recognized standards organization, such as the Society of Automotive Engineers (SAE). In some embodiments, the multilayer stack meets or exceeds SAE standard J2527 and/or SAE standard J2412. In some embodiments, the multilayer stack can increase the resistance to accelerated ultraviolet exposure of an original equipment manufacturer (OEM) automotive head unit screen by, by about, by at least, or by at least about, 150%, 200%, 300%, 400%, 500%, or 600%, or any range of values therebetween (e.g., from roughly 100 hours to roughly 500 hours). Such an ability to withstand simulated exposure to radiation can contribute to substantial retention of color, reduction of degassing, and substantial retention of plasticity over a period of use. In some embodiments, the multilayer stack is configured to withstand exposure to temperature changes and/or radiation over for, for about, for at least, or for at least about, 1, 2, 3, 4, 5, 6, 7, 8, 9 or 10 years, or any rage of values therebetween, without, or without substantial, degradation (e.g., color change (e.g., yellowing), degassing, and/or loss of plasticity). Radiation (e.g., ambient radiation) can include solar radiation, which comprises solar ultraviolet (UV) radiation. In some embodiments, the multilayer stack is configured to be removed from a screen after being applied to the screen for, for about, for at least, or for at least about, 1, 2, 3, 4, 5, 6, 7, 8, 9, 10, 11, 12, 13, 14, 15, 16, 17, 18, 19 or 20 years without leaving residue (e.g., adhesive residue, silicon-based layer residue, torn portions or pieces of the multilayer stack) on the screen.

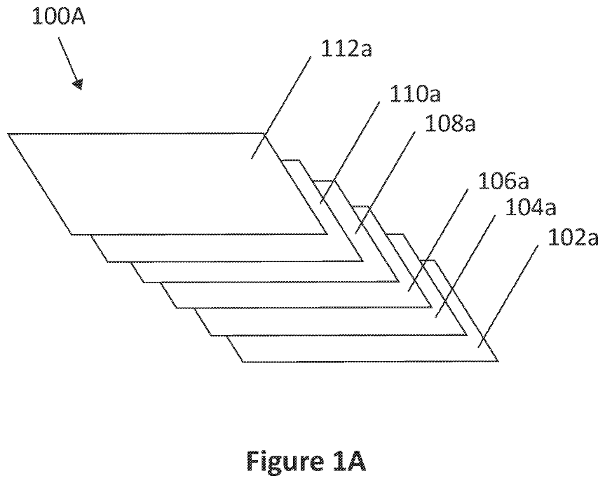

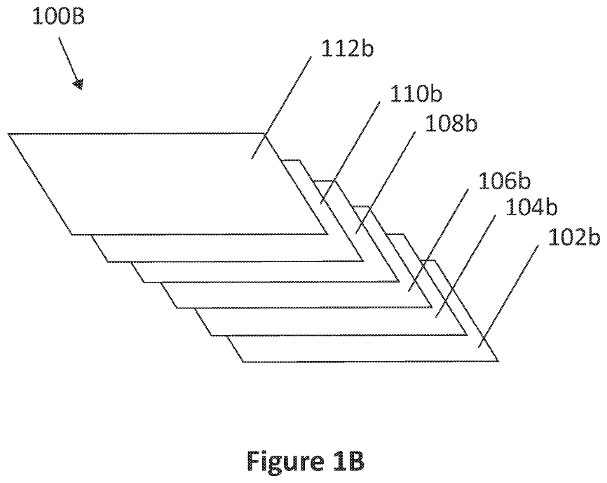

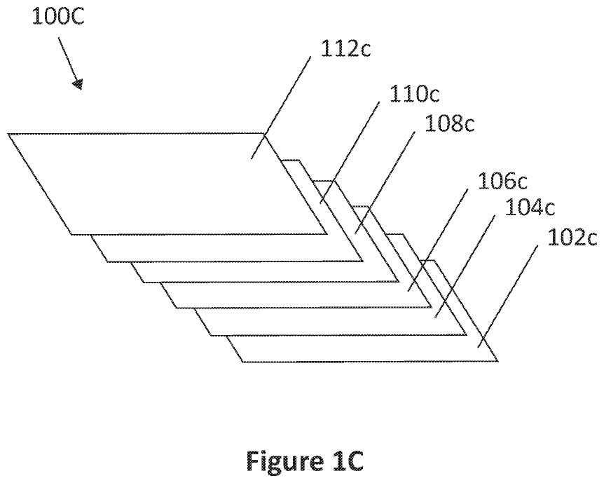

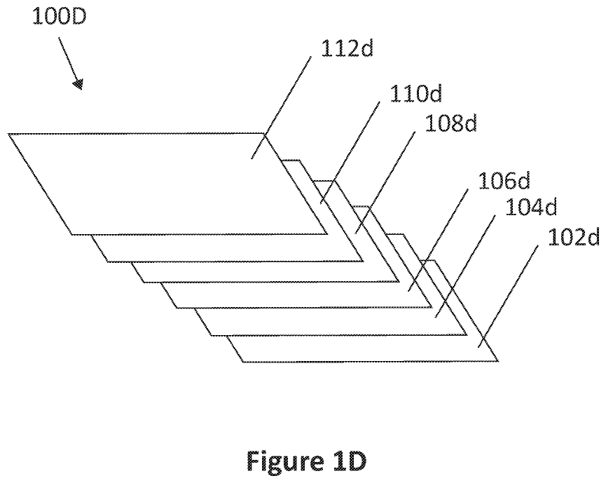

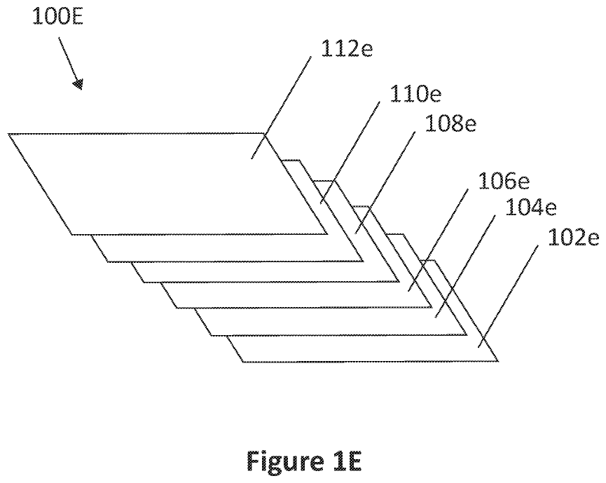

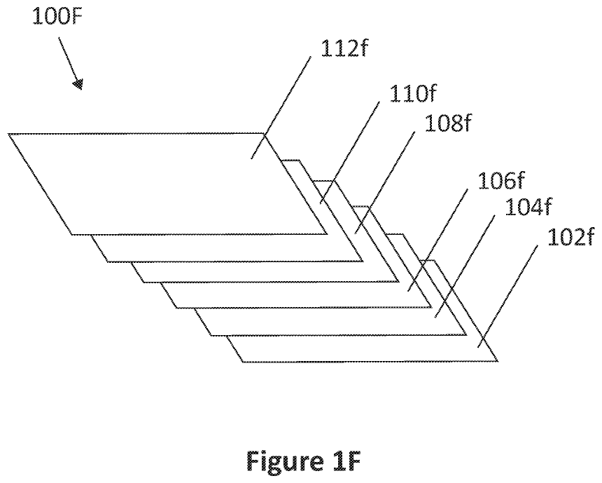

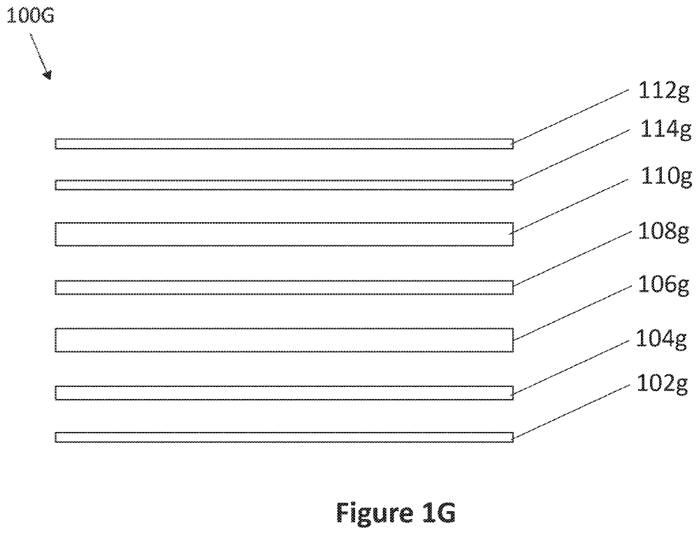

FIG. 1A illustrates a multilayer stack 100A for protecting a screen, in an exploded view. In the illustrated example of FIG. 1A, the bottom-most layer of the multilayer stack 100A is a release layer 102a. Disposed directly over the release layer 102a is a silica gel layer 104a. Disposed directly over the silica gel layer 104a is a polyethylene terephthalate (PET) layer 106a. Disposed directly over the PET layer 106a is an optically clear adhesive (OCA) layer 108a. Disposed directly over the OCA layer 108a is a tempered glass layer 110a. In the illustrated example of FIG. 1A, the tempered glass layer 110a is a high-definition tempered glass layer with implanted antibacterial silver ions. In some embodiments, “high-definition” refers to clarity and transmissivity of the glass layer. And disposed directly over the tempered glass layer 110a is an anti-fingerprint layer 112a.

FIG. 1B illustrates a multilayer stack 100B for protecting a screen, in an exploded view. In the illustrated example of FIG. 1B, the bottom-most layer of the multilayer stack 100B is a release layer 102b. Disposed directly over the release layer 102b is a silica gel layer 104b. Disposed directly over the silica gel layer 104b is a polyethylene terephthalate (PET) layer 106b. Disposed directly over the PET layer 106b is an optically clear adhesive (OCA) layer 108b. Disposed directly over the OCA layer 108b is a tempered glass layer 110b. In the illustrated example of FIG. 1B, the tempered glass layer 110b is a matte-finished tempered glass layer with implanted antibacterial silver ions. And disposed directly over the tempered glass layer 110b is an anti-fingerprint layer 112b.

FIG. 1C illustrates a multilayer stack 100C for protecting a screen, in an exploded view. In the illustrated example of FIG. 1C, the bottom-most layer of the multilayer stack 100C is a release layer 102c. Disposed directly over the release layer 102c is a silica gel layer 104c. Disposed directly over the silica gel layer 104c is a rectify polarization polyethylene terephthalate (PET) layer 106c. Disposed directly over the rectify polarization PET layer 106c is an optically clear adhesive (OCA) layer 108c. Disposed directly over the OCA layer 108c is a tempered glass layer 110c. In the illustrated example of FIG. 1C, the tempered glass layer 110c is a high-definition tempered glass layer with implanted antibacterial silver ions. And disposed directly over the tempered glass layer 110c is an anti-fingerprint layer 112c.

FIG. 1D illustrates a multilayer stack 100D for protecting a screen, in an exploded view. In the illustrated example of FIG. 1D, the bottom-most layer of the multilayer stack 100D is a release layer 102d. Disposed directly over the release layer 102d is a silica gel layer 104d. Disposed directly over the silica gel layer 104d is a rectify polarization polyethylene terephthalate (PET) layer 106d. Disposed directly over the rectify polarization PET layer 106d is an optically clear adhesive (OCA) layer 108d. Disposed directly over the OCA layer 108d is a tempered glass layer 110d. In the illustrated example of FIG. 1D, the tempered glass layer 110d is a matte-finished tempered glass layer with implanted antibacterial silver ions. And disposed directly over the tempered glass layer 110d is an anti-fingerprint layer 112d.

FIG. 1E illustrates a multilayer stack 100E for protecting a screen, in an exploded view. In the illustrated example of FIG. 1E, the bottom-most layer of the multilayer stack 100E is a release layer 102e. Disposed directly over the release layer 102e is a silica gel layer 104e. Disposed directly over the silica gel layer 104e is a polyethylene terephthalate (PET) layer 106e. Disposed directly over the PET layer 106e is an optically clear adhesive (OCA) layer 108e. Disposed directly over the OCA layer 108e is a tempered glass layer 110e. In the illustrated example of FIG. 1E, the tempered glass layer 110e is a tempered 9H glass layer. And disposed directly over the tempered glass layer 110e is an anti-fingerprint layer 112e.

FIG. 1F illustrates a multilayer stack 100F for protecting a screen, in an exploded view. In the illustrated example of FIG. 1F, the bottom-most layer of the multilayer stack 100F is a release layer 102f. Disposed directly over the release layer 102f is a silica gel layer 104f. Disposed directly over the silica gel layer 104f is a polarized polyethylene terephthalate (PET) layer 106f. Disposed directly over the polarized PET layer 106f is an optically clear adhesive (OCA) layer 108f. Disposed directly over the OCA layer 108f is a tempered glass layer 110f. In the illustrated example of FIG. 1F, the tempered glass layer 110f is a tempered 9H glass layer with anti-glare properties and with implanted antibacterial silver ions. And disposed directly over the tempered glass layer 110f is an anti-fingerprint layer 112f.

FIG. 1G illustrates a multilayer stack 100G for protecting a screen, in an exploded side view. In the illustrated example of FIG. 1G, the bottom-most layer of the multilayer stack 100G is a release layer 102g. Disposed directly over the release layer 102g is a silicone adhesive layer 104g. Disposed directly over the silicone adhesive layer 104g is a triacetate cellulose (TAC) layer 106g. Disposed directly over the TAC layer 106g is an optically clear adhesive (OCA) layer 108g. Disposed directly over the OCA layer 108g is an ACG glass layer 110g. Disposed directly over the ACG glass layer 110g is an anti-reflective layer 114g. And disposed directly over the anti-reflective layer 114g is an anti-fingerprint layer 112g. The anti-fingerprint layer 112g has anti-bacterial properties.

In some embodiments, the release layer protects the silicon-based layer (e.g., silica gel and/or silicone adhesive layer) and the remainder of the multilayer stack from damage (e.g., scratches) or contamination (e.g., dust, dirt, and fingerprint residue) during shipment until installation. In some embodiments, during installation of the multilayer stack onto a substrate (e.g., a sheet of glass, a screen, a head unit screen), the release layer is separated (e.g., peeled) from the remainder of the multilayer stack, thereby exposing the silicon-based layer. In some embodiments, the remainder of the multilayer stack can then be disposed over and/or applied to a substrate.

### EXAMPLES

### Example 1

Ten sample multilayer stacks consistent with FIGS. 1A-1F were manufactured and tested. Each of the ten sample multilayer stacks comprised the following layers and approximate specified thicknesses: a silica gel layer (0.03 mm±0.05 mm), on which was disposed a PET layer (0.05 mm±/−0.03 mm), on which was disposed an OCA layer (0.1 mm±0.05 mm), on which was disposed a tempered glass layer (0.33 mm), on which was disposed an anti-fingerprint layer (0.01 mm).

Six tests were conducted on the samples to test their reliability. The tests and results are provided below.

### 1. Transmittance/Fog

Transmittance/fog was tested. The standard for the light transmittance test is greater than or equal to 90%. The samples tested showed a transmittance of 91.3%.

### 2. Bending

Bending flexibility was tested. The standard for bending flexibility is greater than or equal to 180°. The samples tested showed a bending flexibility of greater than 180°.

### 3. Impact Resistance

Impact resistance was tested using a falling ball test. A metallic ball with a mass of 64 grams was dropped from a height of 60 cm. All 10 samples passed this test.

### 4. Edge Strength and Compressive Strength

Edge strength and compressive strength were tested using an edge pressure test, in which the data crushed by the middle point of the long side prevailed. The edge pressure standard was 13 kg. Results of each sample are provided in Table 1 below.

### 5. Initial Droplet Angle

Initial water droplet angle was tested. After grinding, friction was made at the center point. The friction position was marked. Humidity was not higher than 55°. Every time the steel velvet was changed, the steel velvet was not moistened. The initial water droplet angle standard was 110°. Results of each sample are provided in Table 1 below.

### 6. Post-Grinding Droplet Angle

Post-grinding water droplet angle was tested. After the initial droplet test (see Test 5, above), the surface was cleaned using a grinding process. The average value of the five points were tested and recorded. The post-grinding water droplet standard was 105°. Results of each sample are provided in Table 1 below.

TABLE 1

Test Results

| | Edge Pressure | Initial Drop | Post-Grinding |
|---|---|---|---|
| Sample # | Test | Angle | Angle |
| Standard | 13 (kg) | 110 (degrees) | 105 (degrees) |
| 1 | 14.15 | 110 | 105 |
| 2 | 14.07 | 111 | 106 |
| 3 | 14.16 | 110 | 105 |
| 4 | 14.42 | 110 | 104 |
| 5 | 14.60 | 111 | 107 |
| 6 | 14.35 | 111 | 106 |
| 7 | 14.40 | 110 | 105 |
| 8 | 14.20 | 111 | 106 |
| 9 | 14.30 | 110 | 105 |
| 10 | 14.32 | 111 | 107 |

### Example 2

Additional sample multilayer stacks consistent with FIG. 1G were manufactured and tested. Each of the tested sample multilayer stacks comprised the following layers and approximate specified thicknesses: a silicone adhesive layer (0.03 mm±0.05 mm), on which was disposed a TAC layer (0.05 mm+/−0.03 mm), on which was disposed an OCA layer (0.1 mm±0.05 mm), on which was disposed an ACG glass layer (0.33 mm), on which was disposed an anti-reflection layer (0.01 mm), on which was disposed an anti-fingerprint layer (0.01 mm).

Fourteen tests were conducted on the samples to test their reliability. All tests were conducted on at least two sample multilayer stacks. All sample multilayer stacks were 14″ screen protectors.

### 1. UV Exposure Operational

Resistance to degradation from ultraviolet (UV) radiation exposure was tested. The industry standard used in this test was SAE J2412. The test was conducted according to the SAE J2412 specification for set up and cycle time. UV exposure was 379.5 kJs, for 253 hours. The acceptable criteria and test results are provided in Table 2 below.

### 2. Low Temperature Operational

Operational performance at low temperature was tested. The industry standard used in this test was TMNA 2011 Low Temperature Resistance (analogous to ISO 16750-45.1.1.2). The test was performed with the sample multilayer stacks mounted to a radio for 100 hours at −40° C. (−40° F.). The acceptable criteria and test results are provided in Table 2 below.

### 3. High Temperature Operational

Operational performance at high temperature was tested. The industry standard used in this test was TMNA 2005 Heat Aging (analogous to ISO 16750-4 5.1.2.2). The test was performed using a radio screen as the coated panel. The test was to 85° C. for 504 hours, to simulate three years of aging. The acceptable criteria and test results are provided in Table 2 below.

### 4. Thermal Shock

Resistance to thermal shock was tested. The industry standard used in this test was ISO 16750-4 5.3.1. The test was performed in accordance with ISO 16750-4 5.3.1. The test included 100 thermal cycles. Each thermal cycle included raising the temperature from −40° C. to 80° C. within 60 seconds or less, then maintaining thermal stability for 60 minutes. The acceptable criteria and test results are provided in Table 2 below.

### 5. Temperature Cycling

Operational performance during temperature cycling was tested. The industry standard used in this test was TMNA 2001 Thermal Cycle (analogous to ISO 16750-4 5.3.1). The test was performed as a group A part, cycling between 100° C. and −40° C. The acceptable criteria and test results are provided in Table 2 below.

### 6. Humidity Test

Resistance to humidity was tested. The industry standard used in this test was TMNA 2008 Humidity Resistance (analogous to ISO 16750-4 5.7). The test was performed to 70° C. and 90% humidity for 100 hours. The acceptable criteria and test results are provided in Table 2 below.

### 7. Vibration Test

Resistance to vibrations was tested. The industry standard used in this test was TMNA 3035 Vibration Test (analogous to ISO 16750-3 4.1.3.1.5). The test frequency was between 5 and 200 hertz, for 900 seconds, at a 90-degree vertical axis, at a temperature of 24.3° C. and humidity of 51%. The acceptable criteria and test results are provided in Table 2 below.

### 8. Mechanical Shock

Resistance to mechanical shock was tested. The industry standard used in this test was ISO 16750-3 4.2.2 Mechanical Shock Test for Components on Rigid Points on Body. Each test included 10 shocks of an acceleration of 500 m/s² for 6 ms, at a temperature of 25° C. The acceptable criteria and test results are provided in Table 2 below.

### 9. Scratch Test

Scratch resistance was tested. The industry standard used in this test was ISO 15184. A Wolff-Wilborn test was conducted, including a 500 g weight and 9H pencil and a rolling speed of 10 mm/s. Five separate positions were tested. The acceptable criteria and test results are provided in Table 2 below.

### 10. Chemical Test

Chemical resistance was tested. The industry standard used in this test was TMNA 1007 Chemical Resistance (analogous to ISO 16750-5 5.1). The test was performed according to interior parts chemical list. The acceptable criteria and test results are provided in Table 2 below.

### 11. Abrasion Test

Abrasion resistance was tested. The test included rubbing a 2″ section of the sample multilayer stack with a 1-pound weighted cloth. Five samples were rubbed 6,000 times. The rubbing was repeated for damp cloth, jeans, and steel wool. The acceptable criteria and test results are provided in Table 2 below.

### 12. Flammability Test

Fire resistance was tested. The industry standard used in this test was FMVSS 302. The test was performed according to the specified standard. The acceptable criteria and test results are provided in Table 2 below.

### 13. Three-Point Bend Test

Flexibility was tested. The test included starting a press shaft of the equipment to gradually press the sample multilayer stack from three directions (up, left, and right). Pressure was applied slowly to see whether the stack could withstand a bearing force of at least 15 kg. The acceptable criteria and test results are provided in Table 2 below.

### 14. Edge Strength Test

Edge strength was tested. The test included pressing a cone head on the surface of the sample multilayer stack. The gravity was gradually increased to the maximum bearing gravity of the sample stack, to see whether the breaking value was at least 6 kg. The acceptable criteria and test results are provided in Table 2 below.

TABLE 2

| Test # | Summary | Acceptance Criteria | Result |
|---|---|---|---|
| 1 | UV Operational | No blistering and yellowing. Glass | Passed |
| | | display is free of residue, via | |
| | | physical inspection and touch/feel. | |
| | | Samples have same clarity relative | |
| | | to control samples. | |
| 2 | Low Temp | No cracking, deformation, | Passed |
| | Operational | discoloration, stratification | |
| | | or degradation of adhesive. | |
| 3 | High Temp | No cracking, deformation, | Passed |
| | Operational | discoloration, stratification | |
| | | or degradation of adhesive. | |
| 4 | Thermal | No cracking, deformation, | Passed |
| | Shock | discoloration, stratification | |
| | | or degradation of adhesive. | |
| 5 | Temperature | No cracking, deformation, | Passed |
| | Cycling | discoloration, stratification | |
| | | or degradation of adhesive. | |
| 6 | Humidity | No cracking, deformation, | Passed |
| | Test | discoloration, stratification | |
| | | or degradation of adhesive. | |
| 7 | Vibration | After test, no deformation, | Passed |
| | Test | no falling off, no breaking | |
| | | of sample under test. | |
| 8 | Mechanical | After test, no deformation, | Passed |
| | Shock | no falling off, no breaking | |
| | | of sample under test. | |
| 9 | Scratch | Verify hardness >= 9H | Passed |
| | Test | No cracking, deformation, | |
| | | scratching or denting. | |
| 10 | Chemical | Free of discoloration, patterning, | Passed |
| | Test | changes to texture. | |
| 11 | Abrasion | Free of discoloration, patterning, | Passed |
| | Test | or distortion. | |
| 12 | Flamability | Calculated burn rate passes | Passed |
| | Test | test expectation. | |
| 13 | Three Point | Do not break or crack before | Passed |
| | Bend Test | bearing 15 kg. | |
| 14 | Edge Strength | Do not break or crack before | Passed |
| | Test | bearing 6 kg. | |

### Example 3

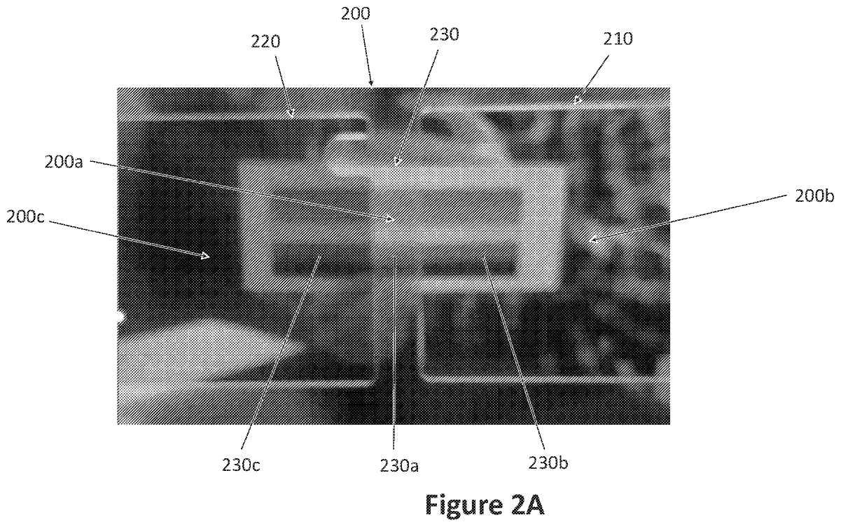

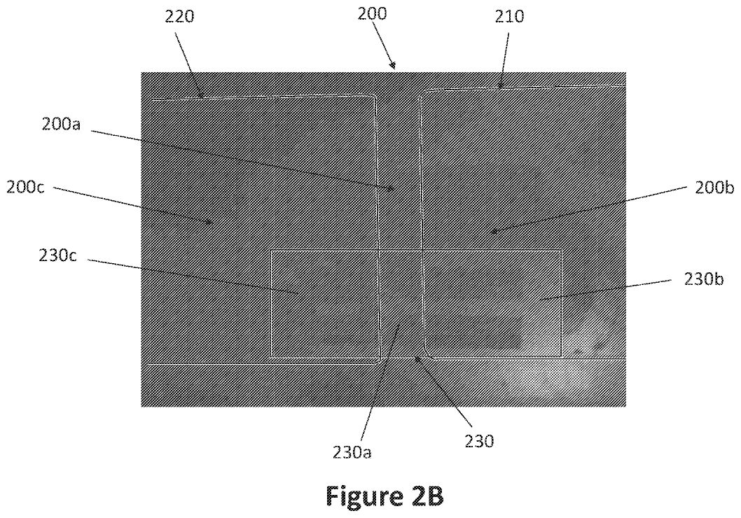

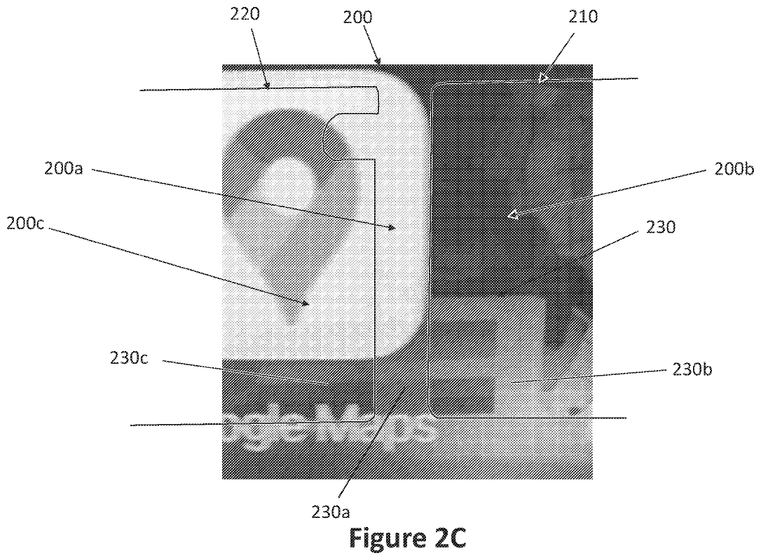

The multilayer stacks of Examples 1 and 2 were also tested for their anti-reflective properties. FIGS. 2A-2C are annotated photographs showing tests comparing indirect reflection of a sample on a screen 200 with a multilayer stack with an anti-reflective layer, with a multilayer stack without an antireflective layer, and without any multilayer stack. The screen 200 shown in each of FIGS. 2A-2C have three different domains. The first regime 200a of the screen 200 is bare, without a multilayer stack for protecting the screen 200. The second regime 200b of the screen 200 has a first multilayer stack 210 disposed thereon. The first multilayer stack 210 does not have an anti-reflective layer and is similar to the multilayer stack of Example 1. The third regime 200c of the screen 200 has an anti-reflective multilayer stack 220 disposed thereon. The anti-reflective multilayer stack 220 is the multilayer stack of Example 2. Each of FIGS. 2A-2C also show the indirect reflection of a sample: reflected sample 230. A first portion 230a of the reflected sample 230 is seen on the bare screen 200. A second portion 230b of the reflected sample 230 is seen on the first multilayer stack 210 that does not comprise an anti-reflection layer. A third portion 230c of the reflected sample 230 is seen on the anti-reflective multilayer stack 220 that comprises an anti-reflection layer.

In FIG. 2A, the screen 200 is off and black. In FIG. 2B, the screen 200 is on and blue. In FIG. 2C, the screen 200 is on and showing multiple colors. Specifically, FIG. 2C shows a screen with a navigation application on it, which is a common test case for many contemporary screens (e.g., phone screens and/or vehicle head units). In FIGS. 2B and 2C, both multilayer stacks 210, 220 and the sample 230 are outlined in red to increase clarity of the borders separating the first portion 230a, second portion 230b, and third portion 230c of the sample 230. As demonstrated by FIGS. 2A-2C, the anti-reflective multilayer stack shows improved indirect anti-reflective properties relative to the bare screen and the multilayer stack without an anti-reflective layer when the screen is both on and off.

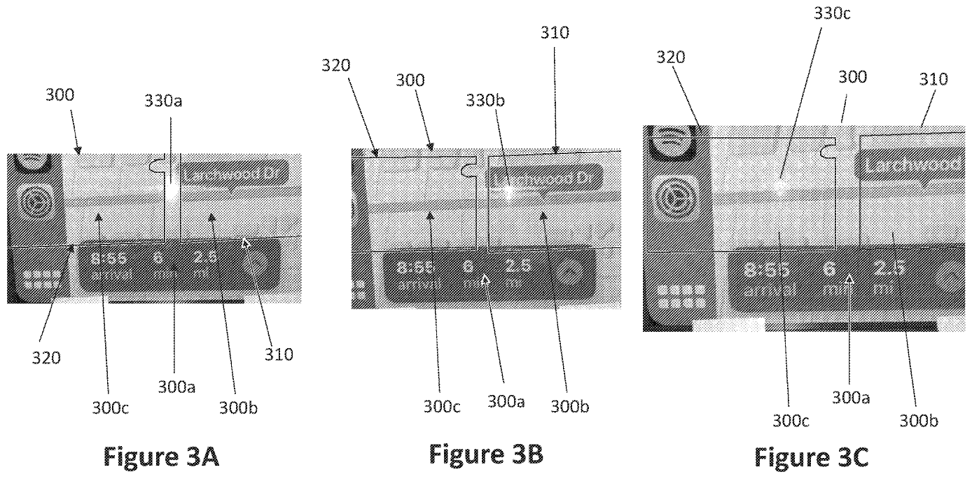

FIGS. 3A-3C are annotated photographs showing tests comparing direct reflection (e.g., glare) of a light source on a screen 300 with a multilayer stack with an anti-reflective layer, with a multilayer stack without an antireflective layer, and without any multilayer stack. The screen 300 shown in each of FIGS. 3A-3C is the same. The screen 300 shown in each of FIGS. 3A-3C display a navigation application on it, which is a common test case for many contemporary screens (e.g., phone screens and/or vehicle head units). The screen 300 shown in each of FIGS. 3A-3C have three different domains. The first regime 300a of the screen 300 is bare, without a multilayer stack for protecting the screen 300. The second regime 300b of the screen 300 has a first multilayer stack 310 disposed thereon. The first multilayer stack 310 does not have an anti-reflective layer and is similar to the multilayer stack of Example 1. The third regime 300c of the screen 300 has an anti-reflective multilayer stack 320 disposed thereon. The anti-reflective multilayer stack 320 is the multilayer stack of Example 2.

Each of FIGS. 3A-3C also show the direct reflection (e.g., glare) of a light source on each regime of the screen 300. FIG. 3A shows a first glare 330a of a light source reflecting off of the bare screen 300. FIG. 3B shows a second glare 330b of the light source reflecting off of the second regime 300b of the screen 300, the part of the screen 300 protected by a multilayer stack 310 without the anti-reflection layer. FIG. 3C shows a third glare 330c of the light source reflecting off of the third regime 300c of the screen 300, the part of the screen 300 protected by an anti-reflective layer multilayer stack 320 that comprises an anti-reflection layer. It will be understood that the glare shown in each of FIGS. 3A-3C is of the same light source on the same screen with the same brightness. Differences in the sizes and brightnesses of the first glare 330a, second glare 330b, and third glare 330c is attributed to the properties of the multilayer stacks. For example, the fact that the second glare 330b is smaller than the first glare 330a is attributed to the anti-reflective (e.g., anti-glare) properties of the multilayer stack 310 without the additional anti-reflective layer. And the fact that the third glare 330c is smaller than the first glare 330a is attributed to the anti-reflective (e.g., anti-glare) properties of the anti-reflective multilayer stack 320. As demonstrated by FIGS. 3A-3C, the anti-reflective multilayer stack shows improved direct anti-reflective properties (i.e., anti-glare properties) relative to the bare screen and the first multilayer stack without an anti-reflective layer when the screen is both on and off. Also, the first multilayer stack shows improved direct anti-reflective properties (i.e., anti-glare properties) relative to the bare screen.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Moreover, as used herein, when a first element is described as being “on” or “over” a second element, the first element may be directly on or over the second element, such that the first and second elements directly contact, or the first element may be indirectly on or over the second element such that one or more elements intervene between the first and second elements. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments.

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further embodiments. The accompanying claims and their equivalents are intended to cover such forms or modifications as would fall within the scope and spirit of the disclosure.

1. A multilayer stack for protecting a screen, comprising:
a bottom layer;
a top layer; and
a plurality of interlayers disposed between the bottom layer and top layer,
wherein the top layer is above the plurality of interlayers and the bottom layer is below the plurality of interlayers, and
wherein the plurality of interlayers comprises an optically clear adhesive layer.

2. The multilayer stack of claim 1, wherein the multilayer stack is optically transparent.

3. The multilayer stack of claim 1, further comprising a release layer disposed directly below the bottom layer.

4. The multilayer stack of claim 1, wherein the plurality of interlayers comprises an anti-refraction layer.

5. The multilayer stack of claim 4, wherein the anti-refraction layer is a polarized PET layer.

6. The multilayer stack of claim 5, wherein the polarized PET layer comprises a circular polarizer.

7. The multilayer stack of claim 1, wherein the plurality of interlayers further comprising a glass layer.

8. The multilayer stack of claim 1, wherein the plurality of interlayers further comprising an anti-reflection layer.

9. The multilayer stack of claim 1, wherein the multilayer stack is configured to not substantially form bubbles between the stack and the screen over a useful life.

10. The multilayer stack of claim 1, wherein the multilayer stack is configured to withstand exposure to ambient radiation over a useful life without substantial degradation.

11. The multilayer stack of claim 1, wherein the multilayer stack meets or exceeds an SAE J2527 accelerated exposure standard.

12. The multilayer stack of claim 1, wherein the multilayer stack is configured to substantially retain its color over a useful life.

13. The multilayer stack of claim 1, wherein the multilayer stack is configured to substantially retain its plasticity over a useful life.

14. The multilayer stack of claim 9, wherein the useful life is 5 years.

15. The multilayer stack of claim 1, wherein the multilayer stack is configured to be easily removable from a glass element after 12 years of being directly disposed over the glass element without leaving residue on the glass element.

16. A device, comprising a screen and the multilayer stack of claim 1, wherein the screen is disposed directly below the bottom layer.

17. The device of claim 16, wherein the screen is a head unit screen.

18. A vehicle comprising the device of claim 16.

19. A method of applying a screen protector to a screen, comprising disposing the multilayer stack of claim 1 to a screen.

20. The method of claim 19, wherein the multilayer stack further comprises a release layer disposed directly below the bottom layer, and further comprising removing the release layer from the multilayer stack prior to disposing the multilayer stack to the screen.

21. A multilayer stack for protecting a screen, comprising:
a silicon-based layer;
an anti-refraction layer disposed directly over the silicon-based layer;
an optically clear adhesive layer disposed directly over the anti-refraction layer;
a tempered glass layer disposed directly over the optically clear adhesive layer; and
an anti-fingerprint layer disposed over the tempered glass layer.

22. The multilayer stack of claim 21, wherein the multilayer stack further comprising an anti-bacterial anti-fingerprint layer disposed over the tempered glass layer.

23. The multilayer stack of claim 21, wherein the tempered glass layer comprises silver ions.

24. The multilayer stack of claim 21, wherein the tempered glass layer has anti-glare properties.

25. The multilayer stack of claim 21, wherein an anti-reflection layer is disposed directly over the tempered glass layer.

26. The multilayer stack of claim 21, wherein the optically clear adhesive layer is configured to withstand exposure to ambient radiation over a useful life of at least 5 years without substantial degradation.

27. The multilayer stack of claim 21, wherein the optically clear adhesive layer meets or exceeds an SAE J2527 accelerated exposure standard.
